(19) United States
(12) Patent Application Publication
(10) Pub. No.: US 2016/0255056 A1
(43) Pub. Date: Sep. 1, 2016

(54) APPARATUS AND METHOD FOR MESSAGING SECURITY AND RELIABILITY

(71) Applicant: Open Garden Inc., San Francisco, CA (US)

(72) Inventors: Stanislav Shalunov, Lafayette, CA (US); Gregory Hazel, San Francisco, CA (US); Micha Benoliel, San Francisco, CA (US)

(21) Appl. No.: 14/814,428

(22) Filed: Jul. 30, 2015

Related U.S. Application Data
(60) Provisional application No. 62/126,239, filed on Feb. 27, 2015.

(51) Int. Cl. H04L 29/06; H04L 9/30; H04L 12/58

(52) U.S. Cl. CPC H04L 63/0428; H04L 51/12; H04L 9/30; H04L 2209/24

(57) ABSTRACT

Secure messaging system wherein both the content and the metadata are protected from adversary attack. A message for an intended recipient is decrypted using the intended recipient's public key. The message is then sent to the intended recipient as well as to multitude of decoys. The decoys are real devices that are clustered with the intended recipient according to some method, such as logical or geographical method. The decoys are unable to decrypt the message with their private key and will drop it. Only the intended recipient will be able to decrypt and read the message. Since the message is sent to many recipients (intended recipient and decoys), an adversary is unable to determine who is communicating with whom.

### RELATED APPLICATION

This Application claims priority benefit from U.S. Provisional Application Ser. No. 62/126,239, filed on Feb. 27, 2015, the disclosure of which is incorporated herein by reference in its entirety.

### BACKGROUND

1. Field

This disclosure relates to electronic communication security, useful especially with mobile devices.

2. Related Arts

The traditional understanding of messaging security has centered on confidentiality and, thus, the use of cryptography to conceal the content of the messages. This is unquestionably useful, yet limited. Other aspects of security have been proposed, such as anonymity, pseudonymity, and sender's control over the content of sent messages.

Anonymity and pseudonymity have been in the past offered by anonymous and pseudonymous remailers, such as the original Cypherpunk remailers and the subsequent Mixmaster (Type II) and Mixminion (Type III) systems. These remailers only operate on email and are mostly of historic interest. The ideas of anonymous remailers have formed the foundation of the more modern onion routing, today represented, most notably, by Tor.

Sender's control over sent messages has been, in the past, briefly and unsuccessfully, a focus of Microsoft's efforts. Today, sender's control over the content of sent messages is the value proposition of highly popular Snapchat, demonstrating demand for aspects of security other than confidentiality. Given how little can be done about ensuring sender's control, it is not worth focusing on it, but it is important to mention to illustrate what aspects of security are actually demonstrably important in the real world.

3. Problem to be Solved

While the majority of security industry's effort has gone into protecting the content of messages, the majority of value appears to be in the metadata—who communicates with whom, when, with what frequency, at what time, whether the communication is encrypted or perhaps in an unusual language, etc. The critical importance of metadata is demonstrated, e.g., by the intelligence community's publicly reported attention to it, where the content of the messages, even when available, may be discarded much sooner than the associated metadata. Any rational adversary will likely have similar attitude towards the value of metadata.

Messaging security systems today continue to be built under the false premise that the only thing that matters—or, in a pessimist's assessment, the only issue that can be addressed—is confidentiality protection. Ironically, these systems may provide a net benefit to potential adversaries: the adversary now can't read the content of the messages, but doing so was expensive and, therefore, infrequent to begin with, while the value of having the communication conveniently flagged as encrypted may well outweigh, for the adversary, the ability to read the content.

In other words, the use of a typical modern security system in fact makes a typical attacker's job easier: the attacker uses the convenient flag of encryption to locate the traffic it should pay attention to and then extracts and analyzes completely unprotected metadata. Today, the relative value of data and metadata for a typical attacker can be seen from duration of their storage: the data, even when it is readily available and unprotected, is only stored for days in the general case; the results of metadata processing are stored indefinitely.

Therefore, there is a need for system and method that provides enhanced security for metadata.

### SUMMARY

The following summary of the disclosure is included in order to provide a basic understanding of some aspects and features of the invention. This summary is not an extensive overview of the invention and as such it is not intended to particularly identify key or critical elements of the invention or to delineate the scope of the invention. Its sole purpose is to present some concepts of the invention in a simplified form as a prelude to the more detailed description that is presented below.

Various disclosed embodiments enable secure messaging system that provides integrated security. The embodiments offer the conventional level of confidentiality and authentication. Additionally, the embodiments protect message metadata from traffic analysis and offer more resilient communication when an adversary is attempting to shut the network down.

Disclosed embodiments address new classes of threats that have not been adequately addressed previously: metadata protection and additional reliability even in the face of an adversary that operates the network. The security properties are all integrated into one coherent package that delivers the totality of the necessary function.

Disclosed embodiments represent a new approach to messaging security, providing protection against a multitude of threats: the traditional passive or active interception, but also traffic analysis, even in the face of the adversary's ability to capture all traffic globally, run man-in-the-middle attacks, participate in the messaging system, and manipulate network topology.

Disclosed embodiments foil attempts to collect and analyze metadata by sending each message to multitude of recipients, only one of which is the intended recipients and the others are decoys. By the method of the embodiments, only the intended recipient is able to decrypt and read the message, while other recipients, i.e., decoys, would drop the message upon failure to decrypt it. Therefore, collection of all of this metadata is taxing on the adversary's system and also meaningless, since the adversary cannot decipher who is indeed communicating with whom.

According to disclosed aspects, a method for sending messages from a sender device to an intended recipient while securing metadata is provided, comprising: assembling a message at the sender device; encrypting the message using a public key of the intended recipient; determining a plurality of decoy devices having association with the intended recipient; and sending the message to the intended recipient and the plurality of decoy devices. The plurality of decoy devices form a geographical cluster with the intended recipient, wherein the plurality of decoy devices and the intended recipient are within a predefined geographical region. Alternatively, or in addition, the plurality of decoy devices form a logical cluster with the intended recipient, wherein the plurality of decoy devices and the intended recipient have a common logical attribute. The logical attribute comprises a sub-set of a unique device identification number. The unique device identification number may comprise one of, e.g., a MAC address and an IMEI number. The method may further comprise a step of sending a public key request prior to encrypting the message. Sending a public key request may comprise sending a request for a public key of a group of users that include the intended recipient. The group of users may be defined by having common characteristics with the intended recipient. The common characteristics may comprise one of, e.g., common subset of phone number digits, common subset of username characters, a common subset of Twitter handle, and common subset of last name characters. The method may further comprise, after decrypting the message, sending the message from the sender device to a secure server, and wherein the steps of determining a plurality of decoy devices having association with the intended recipient and sending the message to the intended recipient and the plurality of decoy devices is performed at the secure server.

According to further disclosed aspects, a method of protecting communication among mobile devices is provided, comprising: establishing a plurality of clusters, each cluster comprising a plurality of mobile devices, each of the plurality of devices having a private key and a public key; whenever a sender device attempts to send a message to a recipient device, performing the steps: assembling the message at the sender device; encrypting the message using the public key of the intended recipient; selecting one of the clusters; sending the message to the intended recipient and to all of the plurality of devices within the selected cluster. The intended recipient belongs to the selected cluster. Establishing a plurality of clusters may comprise associating mobile devices to clusters according to geographical location of the mobile devices. Establishing a plurality of clusters may also comprise associating mobile devices to clusters according to a sub-set of a unique device identification number. The unique device identification number may comprise one of, e.g., a MAC address and an IMEI number. The method may further comprise: whenever one of the plurality of devices receives a message, performing the steps of attempting to decrypt the message using the private key and when the attempt is unsuccessful, dropping the message and when the attempt is successful displaying the message on a screen. The method may further comprise maintaining at a server all of the public keys of the plurality of devices and whenever a sender device attempts to send a message to an intended recipient, performing the steps of sending a public key request from the sender device to the server, and sending a public key response from the server to the sending device. Sending a public key request may comprise sending a request for a public key of a group of mobile devices that include the intended recipient. Sending a public key request may comprise sending a request for a public key of a group of mobile devices having common characteristic. The common characteristics may comprise one of, e.g., common subset of phone number digits, common subset of username characters, common subset of Twitter handle, and common subset of last name characters. The method may further comprise, after decrypting the message, sending the message from the sender device to a secure server, and wherein the steps of selecting one of the clusters and sending the message to the intended recipient and to all of the plurality of devices within the selected cluster is performed at the secure server.

### BRIEF DESCRIPTION OF THE DRAWINGS

The accompanying drawings, which are incorporated in and constitute a part of this specification, exemplify the embodiments of the present invention and, together with the description, serve to explain and illustrate principles of the invention. The drawings are intended to illustrate major features of the exemplary embodiments in a diagrammatic manner. The drawings are not intended to depict every feature of actual embodiments nor relative dimensions of the depicted elements, and are not drawn to scale.

FIG. 1 illustrate schematically a communication system with multiple clusters according to an embodiment of the invention;

FIG. 2 is a flow chart illustrating a process according to an embodiment of the invention;

FIG. 3 is a flow chart illustrating a process according to another embodiment of the invention;

### DETAILED DESCRIPTION

Various embodiments disclosed herein provide security for metadata. The embodiments make it exceedingly difficult for an adversary to determine metadata such as a sender and recipient, and makes it too taxing to attempt to decipher metadata of messages exchanged using the disclosed embodiments.

Metadata is often more valuable than data for real attackers, and yet much less protected. When data confidentiality is concerned, we currently have a well-developed framework of security: encryption, effective key size, resistance to various enumerated attack types. For metadata protection, we currently lack even the most rudimentary framework—what are the basic protection mechanisms, the attacks, the assumptions, etc. This is likely the outcome of the all-or-nothing approach to security. Fort-Knox-level protection is practical on the cryptography side of confidentiality protection with very little cost in CPU, memory, or network traffic. Protection of metadata will come at a cost in network traffic and message latency, and will not be perfect. However, it is useful to quantify its costs and the level of protection afforded.

Suppose we wanted to hide all metadata in a system. Consider the following extreme: each node sends an encrypted message of the same length each minute; all messages are delivered to all nodes; there is no addressing on the messages; each node simply attempts to decrypt all messages and only displays to the user those that decrypt successfully.

An attacker can learn very little about who communicates with whom in such a system. The only attack vector is correlating the times when nodes fail to send messages since they are offline. Minimizing time spent offline affords ample protection. This system is hardly practical, but a demonstration that real perfect security of this aspect of the system is, in fact, possible.

Embodiments of the invention use several mechanisms of protection against traffic analysis: making it hard to capture all traffic by decentralizing it, creating its own networks that are expensive to monitor due to their distributed nature, and introducing duplication and delays that, while they do not afford the level of absolute protection of regular broadcasts, also are far more practical to use in a real system.

According to one embodiment, the nodes are clustered so that each cluster has perfect security inside; outside of clusters, it is possible to see which communicate with which, but this offers much lower value to an attacker. Larger clusters are more secure. Smaller clusters are more practical because of lower network traffic overhead. Clusters can be formed pseudorandomly, for example by looking at initial bits of the hash of the participants' public key, by server fill algorithm, or geographically. The geographic clustering offers the additional advantage that much of the in-cluster traffic can be on networks automatically built by clients installed on the mobile devices or a server communicating with such clients.

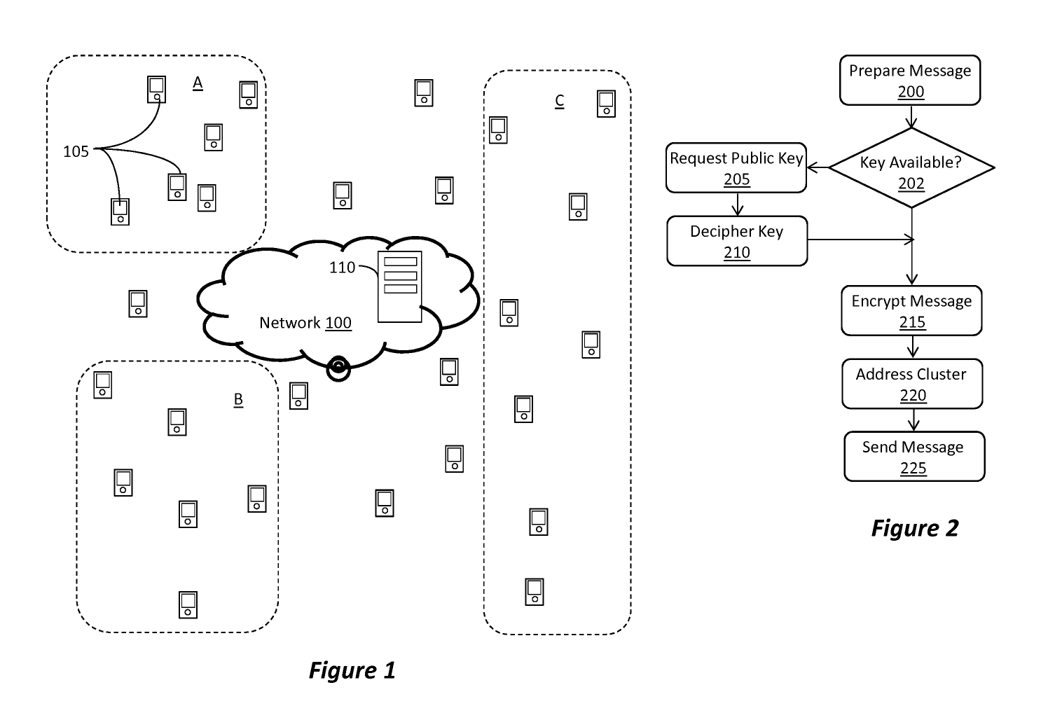

FIG. 1 illustrates a communication system using clusters and decoys according to one embodiment. In FIG. 1, network 100 represent the universe of networks used by mobile devices, such as 3G, 4G, Edge, WiFi, etc. A plurality of mobile devices 105 are shown, although only three are specifically tagged as examples. The devices may communicate among each other, e.g., send SMS messages, emails, files, pictures, etc., via network 100. In this example, the devices may also communicate with each other directly, using WiFi Direct, Bluetooth, NFC, etc. Using direct communication, the devices 105 may also form ad hoc mesh network, as described in, for example, U.S. patent application Ser. No. 13/944,756, filed on Jul. 17, 2013, and Ser. No. 14/231,590, filed Mar. 31, 2014, the disclosure of which is incorporated herein by reference in its entirety. Regardless of the manner in which one device sends a communication to another device, the message has a sender and a target recipient associated with it as metadata, identifying who sent the massage and who the message is intended for. An adversary intercepting these messages may collect such metadata and map who communicates with whom? When? How often? etc. According to the following embodiments, the adversary's ability to collect and decipher such metadata is disrupted.

According to a first embodiment, whenever any of devices 105 sends a message, the message is sent to all of the other devices 105. However, only the intended recipient has the key needed to properly open the message. All other devices don't have the key, so upon unsuccessful attempt to open the message, it is discarded, such that the unintended user is unable to read the messages and is not bombarded with messages not intended for the user's consumption. It should be appreciated that if the adversary intercepts this message, its metadata would be useless, since all of the other devices in the system are indicated as recipients, such that it is impossible for the adversary to decipher who is communicating with whom. That is, the adversary may be able to decipher who is the sender, but not who is the intended recipient.

The above-described method may be implemented using a client app that resides in each participating mobile device 105, or by a server 110. For example, when implemented using the client app, when a user attempts to send a message to an intended recipient, the app modifies the recipient address field to include the addresses of all devices in the system, which may be stored in each device 105. In this respect, an address may be an email address, a phone number, a Twitter handle, etc. When implemented using server 110, the client may send each message having addressed to the server 110. Server 110 then modifies the recipient address field to include the addresses of all devices in the system.

It should be appreciated that the above example is an extreme that, while totally foils any adversary to use metadata, would lead to unacceptable load on the communication network. The other extreme is, of course, the current method of one-to-one communication, wherein each the metadata of each message is accessible. The following embodiment uses a balance between these two extremes, and the balance may be tilted towards more security or less burden on the system, as desired.

Specifically, as shown in FIG. 1, various devices are grouped into clusters, clusters A, B and C shown in FIG. 1. The clusters may or may not include all of the devices in the system. In the particular example of FIG. 1, not all devices are grouped into clusters, so as to demonstrate certain features of this embodiment. Also, this embodiment reflects a point in time wherein not all mobile devices adopt the method of the invention, e.g., not all devices downloaded and installed the proper client app.

There are various manners to decide on the clustering. For example, the clustering may be done using certain computational logic. This embodiment utilizes a unique device identifier to form the clustering. For example, the embodiment may use the MAC address for this logical clustering. MAC addresses are most often assigned by the manufacturer of a network interface controller (NIC) and are stored in its hardware, such as the card's read-only memory or some other firmware mechanism. If assigned by the manufacturer, a MAC address usually encodes the manufacturer's registered identification number and may be referred to as the burned-in address (BIA). The MAC address serves as a unique identifier of a particular device. It may also be known as an Ethernet hardware address (EHA), hardware address or physical address. According to another example the International Mobile Station Equipment Identity or IMEI is used. The IMEI is a unique number assigned to a mobile device, acting as a unique identifier of that device. In all conventional implementation of numbering that uniquely identify a specific device, the number is a series of decimal or hex numbers. In some conventions, such as IMEI, some of the digits signify items other than unique identification of the device. For example, the model and origin comprise the initial 8-digit portion of the IMEI, known as the Type Allocation Code (TAC). The remainder of the IMEI is manufacturer-defined uniquely identifying the particular device, with a Luhn check digit at the end.

According to logic clustering, a portion or a subset of the unique identifier is used to form the clustering. That is, if the entire identifier would be used, it would represent a cluster of a single device—the device that is identified by that particular identifier. However, if only a single digit is used, say the first digit of the manufacturer-assigned identifier, then the cluster will include all devices having the same digit—leading to a very large cluster. Note that since devices are sold worldwide, and users move worldwide, using logical clustering may mean that devices anywhere in the world having that same digit would be included within the cluster. The cluster size may be reduced (at a cost of reduced security), by choosing two, three, or n digits of the total number of digits comprising the identifier (as noted above, including all of the digits would reduce the cluster size to a single device).

According to another embodiment, the clustering is done according to geographical proximity. The geographical clustering can be changed in size to balance security with network load. That is, a cluster of the whole world would be most secure, but would present the most load on the network. Conversely, a geographical clustering of a single home would be practically meaningless in terms of security, but would not pose hardly any load on the network. Thus, a geographical size should be chosen between such extremes. For example, the geographical size may be limited to a city, a county, a state, etc. The larger the geographical area chosen, the more secure the system is, but the more loading is presented on the network.

An advantage of the logical clustering is that it includes devices located remotely from each other, without geographical connection. Conversely, an advantage of the geographical clustering is that it can be done when communicating via ad hoc mesh network, rather than the network 100. Thus, while logical clustering may be more secure or hard to track, geographical clustering is more resilient and can be operable even when the network 100 is down. Therefore, in yet another embodiment both methods are used for clustering. For example, a cross of logical and geographical clustering may be all devices having the first digits of the identifier being 1334, but that are within California. According to another example, logical clustering is used when communicating over network 100, while geographical clustering is used when communicating external to network 100.

The use of the clustering is as follows: when a device 105 sends a message to an intended recipient, the message is addressed and sent to all of the devices in the intended recipient's cluster. Thus, an adversary intercepting this communication cannot tell exactly who is communicating with whom. It also drastically increases resource cost for the adversary to intercept and follow all such communications. When the message arrives at the intended recipient, the device uses a private key to decipher the message and present it to the user on the display. Conversely, when the message arrives at an unintended recipient, the device is unable to decipher it since it doesn't have the proper key. Thus, the device simply drops it and doesn't display anything to the user.

An example of the process according to one embodiment is explained with reference to FIG. 2. This process is described from the sender's perspective. The entire process may be performed by an app operating in the sender's mobile device, or may be performed partially in conjunction with a server. At step 200 the message is being prepared. When preparing the message, a user indicates an intended recipient. This may be done, for example, by choosing a contact from a contact list, entering a phone number, etc. The system then needs the public key of the recipient. Therefore, for example, at step 202 it is checked whether a public key corresponding to the intended recipient is available on the mobile device. If so, the public key is used at 215 to encrypt the message. If not, at 205 a request is sent for a public key.

The request may be sent to a server providing public keys, such as server 110. Server 110 may be a server maintained specifically for serving devices utilizing embodiments of the invention, or may be other server, e.g., a certification authority, such as Symantec (VeriSign), Comodo, GoDaddy, GlobalSign, DigiCert, etc. However, in this embodiment, rather than requesting the public key of the intended recipient, the request is for a group of users which include the intended recipient. For example, if a phone number is used for the intended recipient address (e.g., for SMS messaging), then the request may be for all public keys of users having the same first x-number of digits, e.g., same area code and first three digits of the phone number. This is similar to asking for all of the phone numbers of those living in California and having last name starting with “Ber,” and receiving in response several pages of names and numbers. This is done in order to foil an attempt by an adversary to determine which keys the sender is requesting and therefrom figuring out who the sender is communicating with. The fewer the digits the larger the group, hence the more security but higher burden on the system. For example, if each public key is 100 bytes and the match returns a million users, that would be 100 Megabytes. Thus, the number of digits should be set to enable a manageable number of hits, e.g., 1000 keys.

At 210, when the group of public keys is received, the one matching the intended recipient is deciphered by, e.g., matching the complete phone number, matching username, etc. That public key is then used at 215 to encrypt the message. Then, at 220 all of the targets within the intended recipient's cluster are inserted into the recipient field, such that at 225 the message is sent to all of the recipients within the intended recipient's cluster. The targets within the recipient's cluster may be set using any of the methods described herein. The message may be sent via the network 100, or directly to target devices via a mesh network.

From the recipients' perspective, when each recipient within the cluster receives the message, it attempts to decrypt the message using its private key. If the message does not decrypt, it is dropped. Of course, there would be only one recipient who would be able to decrypt the message using its private key and read the message—that would be the intended recipient whose private key works with the encryption using its public key.

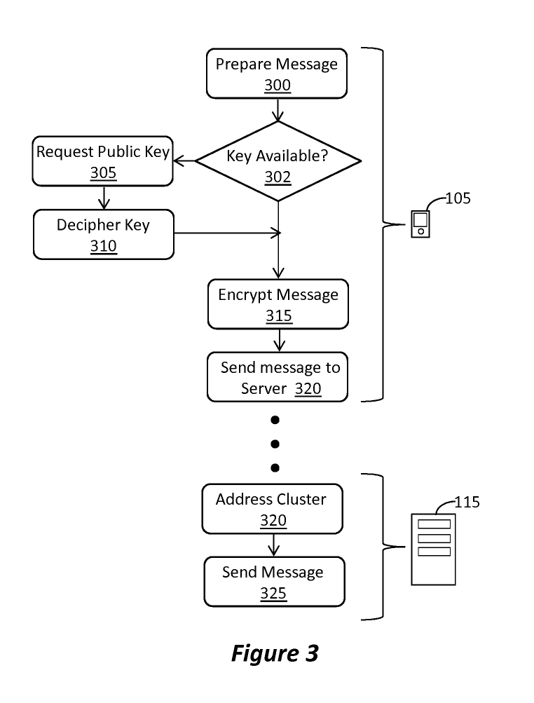

FIG. 3 illustrates another embodiment, wherein the user device 105 communicates with a secure and trusted server 115. The embodiment of FIG. 3 may be somewhat less secure than that of FIG. 2, but it removes some of the computation requirements from the mobile device 105. In FIG. 3, steps 300-315 proceed the same as steps 200-215 in FIG. 2. However, at step 320 the mobile device 105 sends the encrypted message to the secure server. Since the message is encrypted, only the secure server 115 can decrypt it to find out the intended recipient. From the intended recipient, the server 115 determines the proper cluster and at 325 sends the message to all target recipients within the intended recipients' cluster.

It should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein.

The present invention has been described in relation to particular examples, which are intended in all respects to be illustrative rather than restrictive. Those skilled in the art will appreciate that many different combinations of hardware, software, and firmware will be suitable for practicing the present invention. Moreover, other implementations of the invention will be apparent to those skilled in the art from consideration of the specification and practice of the invention disclosed herein. It is intended that the specification and examples be considered as exemplary only, with a true scope and spirit of the invention being indicated by the following claims.

1. A method for sending messages from a sender device to an intended recipient while securing metadata, comprising:
assembling a message at the sender device;
encrypting the message using a public key of the intended recipient;
determining a plurality of decoy devices having association with the intended recipient;
sending the message to the intended recipient and the plurality of decoy devices.

2. The method of claim 1, wherein the plurality of decoy devices form a geographical cluster with the intended recipient, wherein the plurality of decoy devices and the intended recipient are within a predefined geographical region.

3. The method of claim 1, wherein the plurality of decoy devices form a logical cluster with the intended recipient, wherein the plurality of decoy devices and the intended recipient have a common logical attribute.

4. The method of claim 3, wherein the logical attribute comprises a sub-set of a unique device identification number.

5. The method of claim 4, wherein the unique device identification number comprises one of: a MAC address and an IMEI number.

6. The method of claim 1, further comprising a step of sending a public key request prior to encrypting the message.

7. The method of claim 6, wherein sending a public key request comprises sending a request for a public key of a group of users that include the intended recipient.

8. The method of claim 7, wherein the group of users is defined by having common characteristics with the intended recipient.

9. The method of claim 8, wherein the common characteristics comprise one of: common subset of phone number digits, common subset of username characters, a common subset of Twitter handle, and common subset of last name characters.

10. The method of claim 1, further comprising after decrypting the message sending the message from the sender device to a secure server, and wherein the steps of determining a plurality of decoy devices having association with the intended recipient and sending the message to the intended recipient and the plurality of decoy devices is performed at the secure server.

11. A method of protecting communication among mobile devices, comprising:
establishing a plurality of clusters, each cluster comprising a plurality of mobile devices, each of the plurality of devices having a private key and a public key;
whenever a sender device attempts to send a message to a recipient device, performing the steps:
assembling the message at the sender device;
encrypting the message using the public key of the intended recipient;
selecting one of the clusters;
sending the message to the intended recipient and to all of the plurality of devices within the selected cluster.

12. The method of claim 11, wherein the intended recipient belongs to the selected cluster.

13. The method of claim 11, wherein establishing a plurality of clusters comprises associating mobile devices to clusters according to geographical location of the mobile devices.

14. The method of claim 11, wherein establishing a plurality of clusters comprises associating mobile devices to clusters according to a sub-set of a unique device identification number.

15. The method of claim 14, wherein the unique device identification number comprises one of: a MAC address and an IMEI number.

16. The method of claim 11, further comprising: whenever one of the plurality of devices receives a message, performing the steps of attempting to decrypt the message using the private key and when the attempt is unsuccessful, dropping the message and when the attempt is successful displaying the message on a screen.

17. The method of claim 11, further comprising maintaining at a server all of the public keys of the plurality of devices and whenever a sender device attempts to send a message to an intended recipient, performing the steps of sending a public key request from the sender device to the server, and sending a public key response from the server to the sending device.

18. The method of claim 17, wherein sending a public key request comprises sending a request for a public key of a group of mobile devices that include the intended recipient.

19. The method of claim 16, wherein sending a public key request comprises sending a request for a public key of a group of mobile devices having common characteristic.

20. The method of claim 19, wherein the common characteristics comprise one of: common subset of phone number digits, common subset of username characters, common subset of Twitter handle, and common subset of last name characters.

21. The method of claim 11, further comprising after decrypting the message sending the message from the sender device to a secure server, and wherein the steps of selecting one of the clusters and sending the message to the intended recipient and to all of the plurality of devices within the selected cluster is performed at the secure server.
